(19) United States
(12) Patent Application Publication
(10) Pub. No.: US 2009/0151412 A1
(43) Pub. Date: Jun. 18, 2009

(54) MECHANISM FOR LOCKING SHIFT LEVER OF VEHICLE EQUIPPED WITH SMART KEY SYSTEM

(75) Inventors: Jinsang Chung, Suwon-si (KR); Hyungsuk Kim, Hwaseong-si (KR)

Correspondence Address: MORGAN, LEWIS & BOCKIUS LLP (SF), One Market, Spear Street Tower, Suite 2800, San Francisco, CA, 94105, US

(73) Assignees: HYUNDAI MOTOR COMPANY, Seoul (KR); KIA MOTORS CORPORATION, Seoul (KR)

(21) Appl. No.: 12/274,969

(22) Filed: Nov. 20, 2008

(30) Foreign Application Priority Data
Dec. 15, 2007 (KR) 10-2007-0131805

(51) Int. Cl. B60R 25/06

(52) U.S. Cl. 70/247

(57) ABSTRACT

The present invention provides a mechanism for locking a shift lever of a vehicle equipped with a smart key system that can be applied to a vehicle equipped with a smart key system at relatively low cost and convenient to use, and can secure safety against possible accidents by children's misoperation and overcome the defects of mechanisms for locking the steering column in the related art

### CROSS-REFERENCE TO RELATED APPLICATIONS

The present application is based on, and claims priority from, Korean Application Serial Number 10-2007-0131805, filed on Dec. 15, 2007, the disclosure of which is hereby incorporated by reference herein in its entirety.

### FIELD OF THE INVENTION

The present invention relates to a mechanism for locking the shift lever of a vehicle equipped with a smart key system, particularly a technology that restricts motion of the shift lever to prevent carjacking, using a locking mechanism.

### BACKGROUND OF THE INVENTION

According to a vehicle equipped with a smart key system in the related art, when a driver with an authentic FOB key can turn on the power and start the vehicle by pushing a start button.

According to this function, because a smart key controller equipped in the vehicle automatically authenticates the driver using radio communication with the FOB key, it is impossible to start the vehicle without an authentic FOB key.

On the other hand, in addition to locking the doors of a vehicle, locking the steering system, the shift lever, or the transmission has been known as a locking mechanism for preventing carjacking in the related art.

The mechanism for locking the steering system prevents the steering wheel from turning by locking the steering column. In the related art, an ESCL (Electronic Steering Column Lock) is commonly applied to steering columns, but which is expensive and it is impossible to start the vehicle unless the steering column is unlocked by some problems in the steering column. Further, the vehicle does not start until the steering column is completely unlocked, such that the response speed is decreased with a noise. In addition, buckling of the steering wheel is prevented in a car crash.

The mechanism for locking the shift lever according to the related art, as shown in FIG. 1, includes a locking lever 502 that is pivoted by a actuator 500 to prevent a shift lever 504 from pivoting. Further, the mechanism for locking the shift lever includes an unlock button 506 that allows a driver to manually turn locking lever 502 and unlocking lever 508 connected to unlock button 506, for emergency, such that when a drive pushes the unlock button 506, unlocking lever 508 pivots locking lever 502 and shift lever 504 can pivot.

As actuator 500 is activated when the brake pedal is pushed in ignition-On state, shift lever 504 is unlocked from a P-range to an N-range to be able to pivot by locking lever 502, such that the vehicle is in ready for running.

Unlock button 506 is provided for a driver to manually unlock shift lever 504 in an emergency, such as when the vehicle is discharged, but is exposed for anyone to operates. Therefore, when the vehicle is parked on a slope, an accident may be occurred by children's fun.

Further, when the mechanism for locking shift lever 504 is applied to a vehicle with an automatic transmission, shift lever 504 is locked at the P-range, such that it is inconvenient, considering most domestic vehicles are designed to be parked at the N-range.

### SUMMARY OF THE INVENTION

Embodiments of the present invention provide a mechanism for locking a shift lever of a vehicle equipped with a smart key system that can be applied to a vehicle equipped with a smart key system at relatively low cost and convenient to use, and can secure safety against possible accidents by children's misoperation and overcome the defects of mechanisms for locking the steering column in the related art.

According to an embodiment of the invention, a mechanism for locking a shift lever of a vehicle equipped with a smart key system includes a smart key system, a locking lever, a actuator, and a mechanical lock. The smart key system turns on the power and starts the vehicle depending on whether a user is authenticated by an FOB key when a start button is pushed. The locking lever pivots to lock of shift a shift lever from a P-range to another range. The actuator is activated only when the FOB key is authenticated by in the smart key system to unlock the locking lever. The mechanical lock includes an unlock lever that pivots the locking lever to unlock the shift lever and actuates the unlock lever to pivot the locking lever when a mechanical key is inserted and turned.

Further, it is preferable that the mechanical key actuating the mechanical lock is separable from the FOB key.

According to a mechanism for locking a shift lever of an embodiment of the invention, it is possible to prevent an accident by children's misoperation, apply the mechanism to a vehicle equipped with a smart key system at relatively low cost, and park a vehicle at an N-range. Further, the mechanism for locking a shift lever is convenient to use.

Further, according to the mechanism for locking a shift lever, it is possible to overcome or avoid various problems of mechanisms for locking a steering column according to the related art, such as that it is impossible to start a vehicle unless the steering column is completely unlocked by some problems in the steering column, the response speed is decreased with a noise, and buckling of the steering wheel is prevented in a car crash.

### BRIEF DESCRIPTION OF THE DRAWINGS

For better understanding of the nature and objects of the present invention, reference should be made to the following detailed description with the accompanying drawings, in which:

FIG. 1 is a view illustrating an example of a mechanism for locking a shift lever according to the related art;

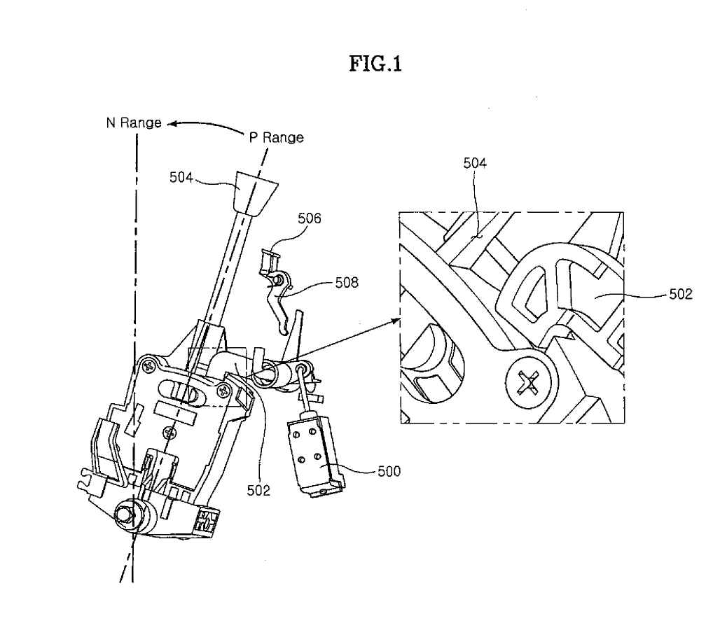

FIG. 2 is a view illustrating the configuration of a mechanism for locking a shift lever of a vehicle equipped with a smart key system according to an embodiment of the invention;

FIG. 3 is a view illustrating a shift lever locked at a P-range, seen from the left and right; and

FIG. 4 is a view illustrating unlocking a locking lever with a mechanical key, seen from the left and right.

### DETAILED DESCRIPTION OF THE PREFERRED EMBODIMENTS

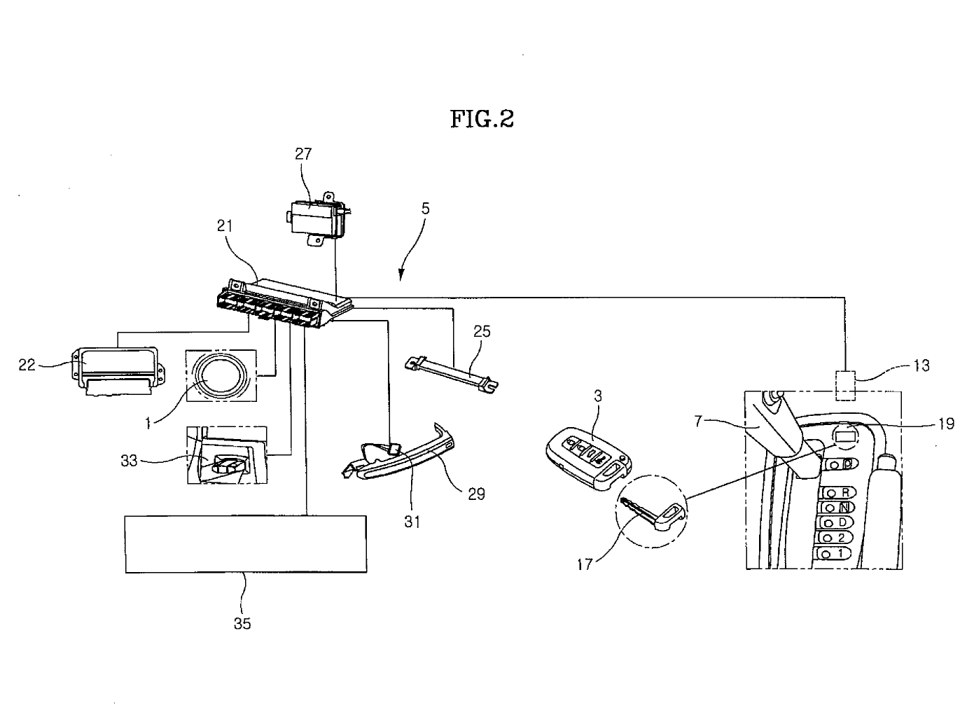

Referring to FIGS. 2 to 4, a mechanism for locking a shift lever of a vehicle equipped with a smart key system includes: a smart key system 5 that turns on the power and starts the vehicle depending on whether a user is authenticated by an FOB key 3 when a start button 1 is pushed; a locking lever 9 that pivots to lock or shift a shift lever 7 from a P-range to another range; a actuator 13 that is activated only when FOB key 3 is authenticated by smart key system 5 to unlock locking lever 9; a mechanical lock 19 that includes an unlock lever 15 that allows locking lever 9 to pivot in order to unlock shift lever 7 and actuates unlock lever 15 to pivot locking lever 9 when a mechanical key 17 is inserted and turned.

In smart key system 5, similar to the related art, a smart key controller 21 is connected with an antenna 25 for LF communication with FOB key 3, a receiver 27 that receives remote control signals from FOB key 3, a door handle sensor 31 that detects the operation of door handle 29, an engine controller 22, a start button 1, an FOB key holder 33 that reads from information of a transponder in the FOB key for an emergency start when a battery of FOB key 3 is discharged, and a power distributor 35 that controls the power of the vehicle.

Actuator 13 is also connected to smart key controller 21. When FOB key 3 is authenticated, actuator 13 is activated and locking lever 9 unlocks shift lever 7, such that shift lever 7 can be operated from the P-range to another range.

Mechanical key 17 that actuates mechanical lock 19 is separable from FOB key 3 for the convenience of a user.

Assuming that a plan that shift lever 7 sweeps when shifting from the P-range to another range is a shift plan Pn, locking lever 9 locks shift lever 7 by pivoting on a plan parallel with shift plan Pn, and unlocking lever 15 pivots locking lever 9 by pivoting on a plan perpendicular to shift plan Pn.

Locking lever 9 has a locking portion 9-1 protruding from the rotational axis of locking lever to lock shift lever 7, a manual unlocking portion 9-2 protruding from the rotational axis of locking lever 9 to receive rotational force from unlocking lever 15, and an automatic unlocking portion 9-3 connected with actuator 13 to receive rotational force, which are integrally formed with locking lever 9.

Mechanical lock 19 includes a cylinder 19-2 having an insertion hole 19-1 where mechanical key 17 is inserted, at the upper portion, and unlocking lever 15 is disposed at the lower portion to receive rotational force from cylinder 19-2.

In a vehicle having the above configuration, when a driver with authentic FOB key 3 pushes start button 1, the power is on and the vehicle starts, in which when the drive steps on the brake pedal, locking lever 9 is unlocked by actuator 13 and shift lever 7 can shift from the P-range to another range, such that the vehicle is in ready for running.

When the vehicles stops running, the power can be off only when shift lever 7 returns to the P-range by smart key controller 21. Therefore, the driver should turns shift lever 7 to the P-range when stopping the vehicle.

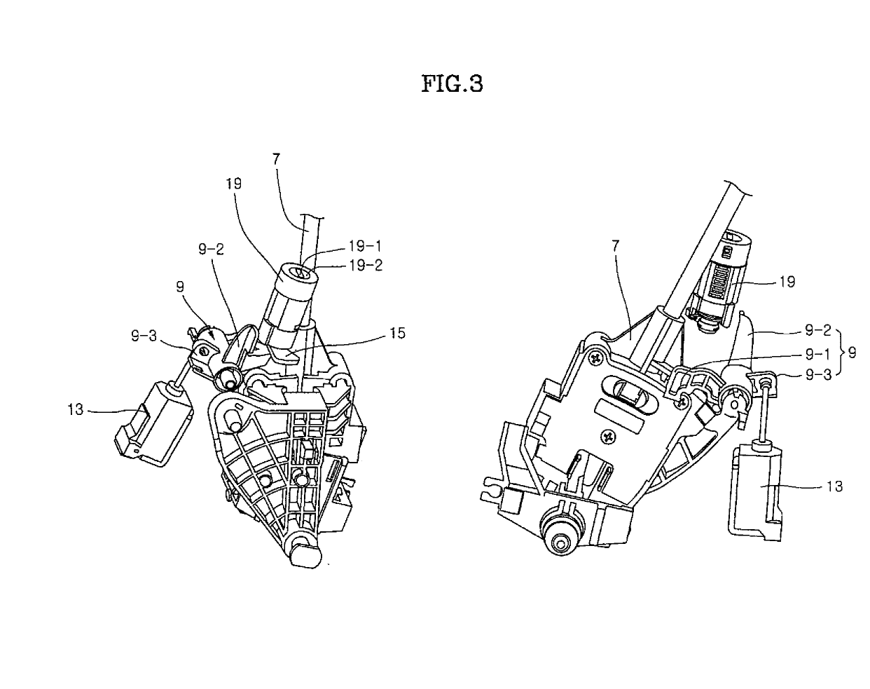

In FIG. 3, shift lever 7 is at the P-range and cannot pivot by locking lever 9. At the P-range, when a driver wants to park the vehicle at the N-range or it is inevitably required to pull the vehicle, the driver can unlock shift lever 7 using mechanical key 17.

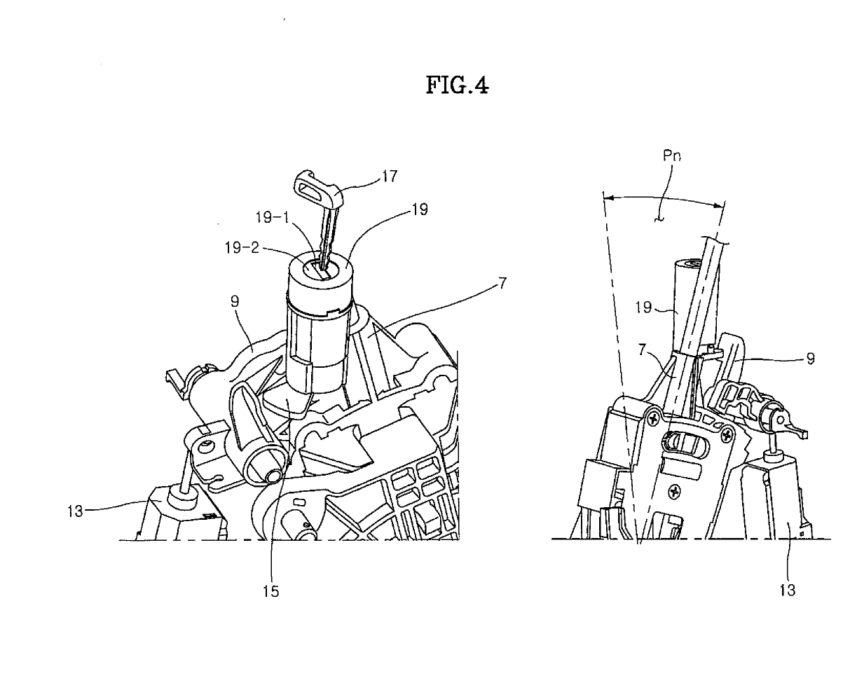

That is, as shown in FIG. 4, when mechanical key 17 is inserted in mechanical lock 19 and then turned, unlock lever 15 pivots and locking lever 9 is pivoted by unlock lever 15, such that shift lever 7 can be shifted to the N-range.

Therefore, according to the above mechanism for locking a shift lever of a vehicle equipped with a smart key system of an embodiment of the invention, it is impossible to unlock shift lever 7 locked at the P-range without mechanical key 17; therefore, it is possible to prevent accidents due to children's misoperation. Further, the mechanism can be applied to a vehicle equipped with a smart key system at relatively low cost, conveniently used, and allows parking at the N-range.

Further, it is possible to overcome or avoid various problems of mechanisms for locking a steering column according to the related art, such as that it is impossible to start a vehicle unless the steering column is completely unlocked by some problems in the steering column, the response speed is decreased with a noise, and buckling of the steering wheel is prevented in a car crash.

What is claimed is:

1. A mechanism for locking a shift lever of a vehicle equipped with a smart key system, comprising:
a smart key system that turns on the power and starts the vehicle depending on whether a user is authenticated by an FOB key when a start button is pushed;
a locking lever that pivots to lock of shift a shift lever from a P-range to another range;
an actuator that is activated only when the FOB key is authenticated by in the smart key system to unlock the locking lever; and
a mechanical lock that includes an unlock lever that pivots the locking lever to unlock the shift lever and actuates the unlock lever to pivot the locking lever when a mechanical key is inserted and turned.

2. The mechanism as defined in claim 1, wherein the mechanical key that actuates the mechanical lock is separable from the FOB key.

3. The mechanism as defined in claim 1, wherein assuming that a plan that the shift lever sweeps when shifting from the P-range to another range is a shift plan,
the locking lever locks the shift lever by pivoting on a plan parallel with the shift plan, and
the unlocking lever pivots the locking lever by pivoting on a plan perpendicular to shift plan.

4. The mechanism as defined in claim 3, wherein the locking lever has:
a locking portion protruding from the rotational axis of the locking lever to lock the shift lever;
a manual unlocking portion protruding from the rotational axis of the locking lever to receive rotational force from the unlocking lever; and
an automatic unlocking portion connected with the actuator to receive rotational force, which are integrally formed with the locking lever.

5. The mechanism as defined in claim 4, wherein the mechanical lock includes a cylinder having an insertion hole where the mechanical key is inserted, at the upper portion, and
the unlocking lever is disposed at the lower portion to receive rotational force from the cylinder
